(19) United States
(12) Patent Application Publication
(10) Pub. No.: US 2015/0276054 A1
(43) Pub. Date: Oct. 1, 2015

(54) Shift Operation Apparatus For Vehicle

(71) Applicant: Atsumitec Co., Ltd., Hamamatsu-shi (JP)

(72) Inventors: Shigeaki ODA, Hamamatsu-shi (JP); Harumichi ISHIZU, Hamamatsu-shi (JP)

(21) Appl. No.: 14/666,862

(22) Filed: Mar. 24, 2015

(30) Foreign Application Priority Data
Mar. 31, 2014 (JP) 2014-071256

(51) Int. Cl. F16H 61/36; F16H 59/10

(52) U.S. Cl. CPC F16H 61/36; F16H 59/10

(57) ABSTRACT

A vehicle shift operation apparatus has a shift lever (2) that is pivotally operated by a driver. A bracket (3) pivotally mounts the shift lever (2). An operation wire Wa connects the shift lever (2) and a vehicle transmission (K). Outer tubes (Wb1, Wb2) cover an external surface portion of the operation wire (Wa). A securing portion (4) secures the outer tube (Wb2) at a predetermined position. The transmission (K) is actuated through the operation wire (Wa) by pivotally operating the shift lever (2). A direction changing mechanism (5) is disposed between the shift lever connecting portion (2a) connected, with the operation wire (Wa), and the securing portion (4) of the outer tube (Wb2). The direction changing mechanism (5) may arbitrarily change the extending direction of the operation wire (Wa).

### CROSS-REFERENCE TO RELATED APPLICATIONS

This application claims the benefit and priority of Japanese Application No. 2014-071256, filed Mar. 31, 2014. The disclosure of the above application is incorporating herein by reference.

### FIELD

The present disclosure relates to a vehicle shift operation apparatus that operates a vehicle transmission through an operation wire pivotally operated by a shift lever.

### BACKGROUND

The operation wire is usually inserted through outer tubes and connects the shift operation apparatus shift lever and the vehicle transmission, more particularly an automatic transmission, to perform an arbitrary operation push-pull operation. This changes gear positions of the transmission by pivotally operating the shift lever. The shift operation apparatus is ordinarily provided with a bracket to pivotally support the shift lever. A securing portion or socket is mounted at a predetermined position on the bracket to secure the outer tube, as disclosed e.g. in Patent Document JP2002-307967.

However, the prior art has following problems. The shift operation apparatus and the transmission are sometimes arranged at different positions on the vehicle body of the vehicle in accordance with the different car models. Thus, the extending direction of the operation wire, connecting the shift operation apparatus and the transmission, should be changed in accordance with the different arranging positions. For example, the extending direction of the operation wire is extremely different when the arranging position of the shift operation apparatus is arranged on a side floor of a driver's seat or on an instrument panel. This is true even though the arranging position of transmission is the same.

In order to efficiently convert the actuating force of the shift lever to motion of the operation wire, it is necessary to form an angle close to 90°, for example, when the shift lever is positioned in N range, between a line passing through the pivotal center of the shift lever and the connecting portion of the operation wire to the shift lever and a line connecting the operation wire and the transmission. Accordingly, it is necessary to change both the position of the connecting portion of the operation wire to the shift lever and the position of the bracket where the securing portion is mounted. Thus, varying configurations of both the shift lever and the bracket for every car model with different relative positions between the shift operation apparatus and the transmission must be taken into consideration.

Thus, it is necessary to largely change configurations of both the shift lever and the bracket for every car model with a different extending direction of the operation wire. This efficiently converts actuating force of the shift lever to motion of the operation wire to transmit the actuating force of the shift lever to the transmission. In turn, this increases the manufacturing cost of vehicles.

### SUMMARY

It is an object of the present disclosure to provide a vehicle shift operation apparatus that can efficiently convert the actuating force of the shift lever to the operation of the operation wire. This occurs by common use of parts, other than a part that secures the securing portion, even in car models with different relative positions between the shift operation apparatus and the transmission.

According to the present disclosure, a vehicle shift operation apparatus comprises a shift lever pivotally operated by a driver. A bracket pivotally mounts the shift lever. An operation wire connects the shift lever and the vehicle transmission. Outer tubes cover an external surface of the operation wire. A securing portion secures the outer tube to a predetermined position. The shift lever is pivotally operated to actuate the transmission through the operation wire. The shift operation apparatus further comprises a direction changing mechanism. The direction changing mechanism is disposed between a connecting portion of the operation wire to the shift lever and the securing portion of the outer tube. This arbitrarily changes the extending direction of the operation wire.

The vehicle shift operation apparatus direction changing mechanism is disposed on the other side of a longitudinal axis of the shift lever with respect to the connecting portion.

The vehicle shift operation apparatus direction changing mechanism further comprises a pulley supporting the operation wire. The pulley is able to rotate in accordance with the pivotal operation of the shift lever.

The vehicle shift operation apparatus direction changing mechanism can arbitrarily change the extending direction of the operation wire. This occurs in accordance with an arbitrary change of the extending direction of the operation wire extending from the direction changing mechanism to the securing portion.

The vehicle shift operation apparatus has a direction changing mechanism disposed between a connecting portion of the operation wire to the shift lever and the securing portion of the outer tube. This arbitrarily changes the extending direction of the operation wire. Thus, it is possible to efficiently convert the actuating force of the shift lever to the operation of the operation wire by utilizing common use of parts other than a part that secures the securing portion. This occurs even in car models with different relative positions between the shift operation apparatus and the transmission.

The direction changing mechanism is disposed on the other side of a longitudinal axis of the shift lever with respect to the connecting portion. Thus, it is possible to reduce the size of the vehicle shift operation apparatus while reducing its dimension in a fore and aft direction.

The direction changing mechanism further comprises a pulley supporting the operation wire. The pulley is able to rotate in accordance with the pivotal operation of the shift lever. Thus, it is possible to surely and smoothly transmit the motion of the operation wire, caused by the shift lever, to the transmission.

The direction changing mechanism can arbitrarily change the extending direction of the operation wire. This occurs in accordance with an arbitrary change of the extending direction of the operation wire extending from the direction changing mechanism to the securing portion. Thus, it is possible for the direction changing mechanism to more easily and surely change the extending direction of the operation wire.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front elevation view of the vehicle shift operation apparatus.

FIG. 2 is a perspective view of a direction changing mechanism where an operation wire is extended toward a direction “a”.

FIG. 3 is a front elevation view of the direction changing mechanism where the operation wire is extended toward the direction “a”.

FIG. 4 is a perspective view of the direction changing mechanism where the operation wire is extended toward a direction “b”.

FIG. 5 is a front elevation view of the direction changing mechanism where the operation wire is extended toward the direction “b”.

FIG. 6 is an exploded perspective view of the direction changing mechanism of FIG. 1.

FIG. 7 is a front elevation view of the direction changing mechanism mounted on a bracket with another configuration and the operation wire extending toward the direction “b”.

### DETAILED DESCRIPTION

Preferable modes for carrying out the present embodiment will be hereinafter described with reference to the accompanying drawings.

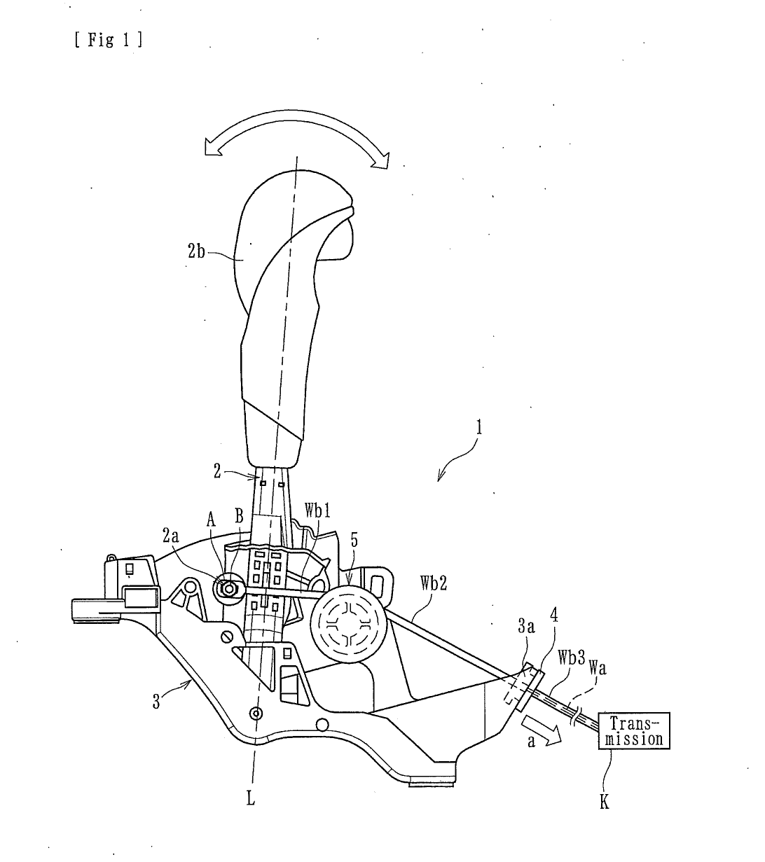

A vehicle shift operation apparatus 1 of the present embodiment is shown in FIG. 1. It includes a shift lever 2, bracket 3, an operation wire Wa, outer tubes Wb1, Wb2, a securing portion 4, and a direction changing mechanism 5. The shift operation apparatus 1 is able to actuate a vehicle transmission K (automatic transmission) by movement of the operating wire Wa via pivotal operation of the shift lever 2.

An operation knob 2b is mounted on top of the shift lever 2. The shift lever 2 is pivotally operated by a driver relative to the bracket 3 through operation of the knob 2b. A base end of the shift lever 2, near the bottom pivotal point, is formed with a connecting portion 2a. One end of the operation wire Wa is connected to the connecting portion 2a. The transmission K can be operated in accordance with arbitrary shift positions (e.g. P range, D range, R range, etc.) by pivotally operating the shift lever 2, as shown by an arcuate arrow in FIG. 1. A reference character L denotes an axial line or axis of the shift lever 2 through its pivotal point.

The bracket 3 pivotally supports the shift lever 2. The bracket 3 is formed from desirable materials by molding. The bracket 3 is adapted to be secured at predetermined positions (e.g. floor or instrument panel etc.) on a vehicle. The bracket 3 is formed with a plurality of apertures or bores to secure bolts and ribs or configurations to mount a solenoid etc. to form a shift-lock mechanism.

The operation wire Wa connects the shift lever 2 and the vehicle transmission K. The operation wire Wa includes a metal fitting A on its base end. The metal fitting A is secured at the side of shift lever 2. The fitting A is fastened by a bolt B (FIG. 1) to the connecting portion 2a. The connecting portion is formed at a predetermined position on the shift lever 2. An external surface of the operation wire Wa is covered by outer tubes (Wb1, Wb2, Wb3). The operation wire Wa can be slid within the outer tubes along their longitudinal direction.

The securing portion 4 is a so-called “socket” which secures the outer tubes (Wb1, Wb2, Wb3) in predetermined positions. The securing portion 4 is adapted to secure the outer tube Wb2 to a securing position 3a of the bracket 3, in the illustrated embodiment. Accordingly, the operation wire Wa is connected to the transmission K at its tip or first end and to the connecting portion 2a of the shift lever 2 at its base or second end. The operation wire Wa is supported on the bracket 3 through the outer tube Wb2 at a position of the securing portion (socket) 4.

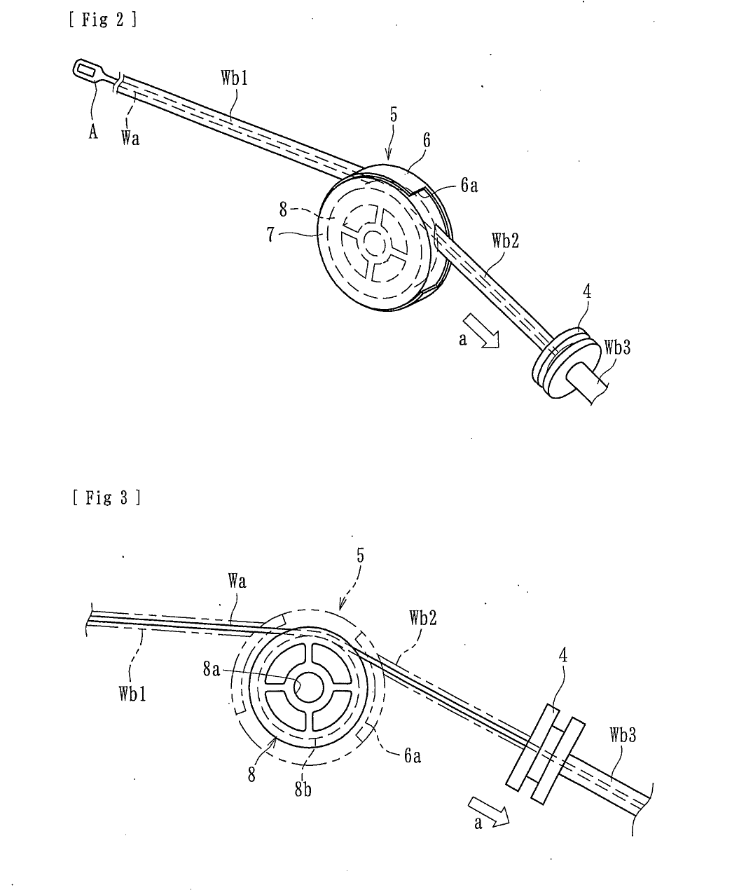

The direction changing mechanism 5 of the present embodiment is disposed between the shift lever connecting portion 2a, connected with the operation wire Wa, and the outer tube securing portion 4. The direction changing mechanism 5 can arbitrarily change the extending direction of the operation wire Wa. The direction changing mechanism 5, as shown in FIGS. 2 to 6, includes a first casing member 6, a second casing member 7 and a disk shaped pulley 8. The first casing member 6 has a substantially cylindrical configuration. The second casing member 7 is combined with the first casing member 6. The disc-shaped pulley 8 is contained within the combined first and second casing members 6, 7.

The first and second casing members 6, 7 are integrally formed with bosses La and Lb, respectively. A central bore 8a is formed in the center of the pulley 8. In addition, the outer tubes Wb1, Wb2 extend respectively from the first and second casing members 6, 7. The operation wire Wa is inserted through the outer tubes Wb1 and Wb2.

The outer tube Wb1 is dimensioned to extend from a predetermined position in the first casing member 6 to the connecting portion 2a of the shift lever 2, The outer tube Wb2 is dimensioned to extend from a predetermined position on the second casing member 7 to the securing portion 4. The outer tube Wb3 extends from the securing portion 4 to the transmission K. Thus, the operation wire Wa is arranged to extend from the connecting portion 2a of the shift lever 2 to the transmission K. The operation wire Wa extends through the outer tube Wb1, the pulley 8 within the first and second casing members 6, 7, the outer tube Wb2, the securing portion 4 and finally the outer tube Wb3.

The first casing member 6 and the second casing member 7 are integrally combined with each other. The pulley 8, via the central bore 8a, is positioned onto the boss La of the first casing member 6. The boss Lb of the second casing member 7 is inserted into the boss La of the first casing member 6. Accordingly, the pulley 8 can be rotationally supported on the bosses La, Lb within the first and second casing members 6, 7. The operation wire Wa is supported on an outer circumferential groove 8b of the pulley 8. Thus, the pulley 8 can be rotated, via the operation wire Wa, during pivotal operation of the shift lever 2.

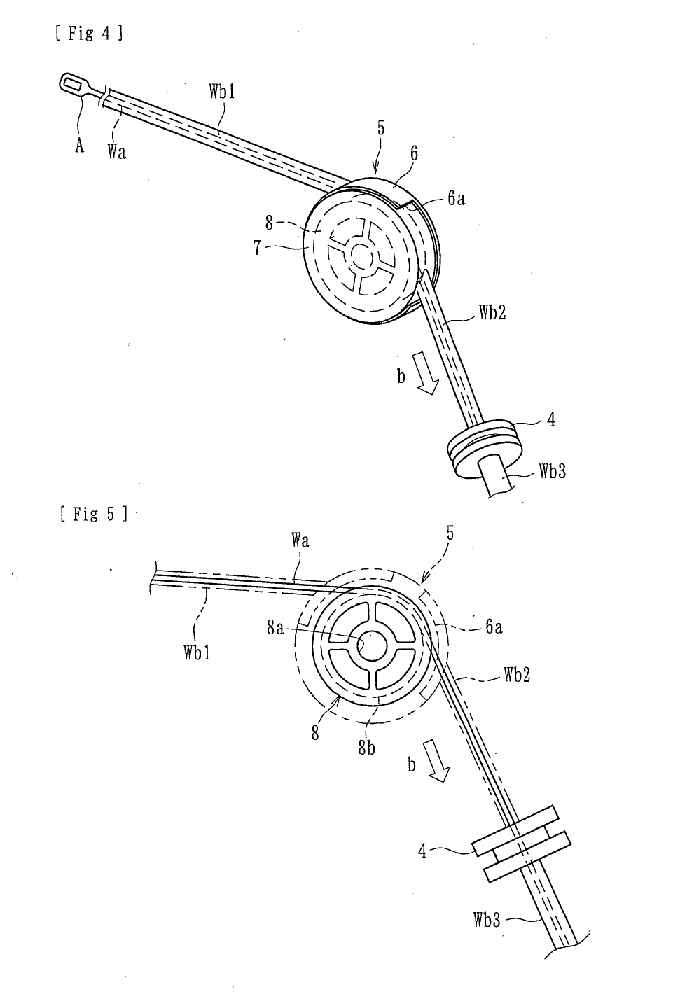

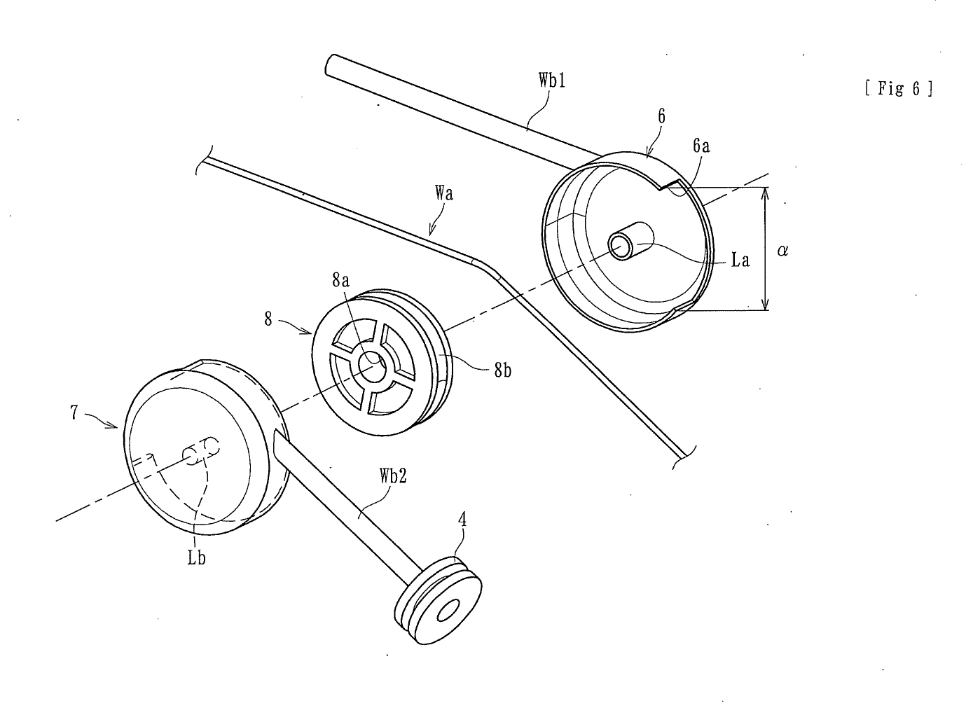

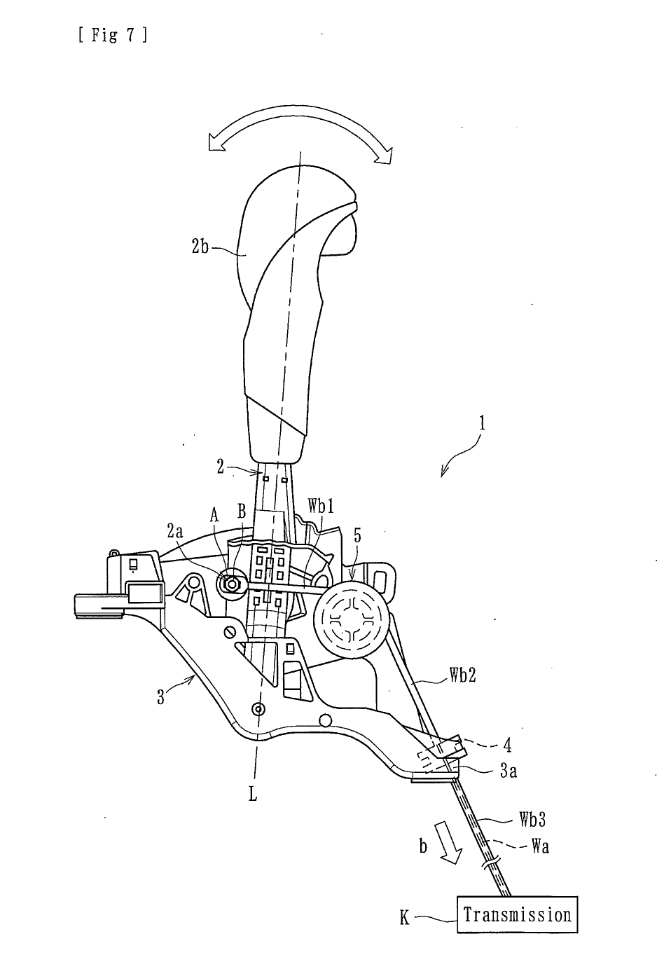

An opening 6a is formed in a side wall of the first casing member 6. The opening 6a defines a circumferential range α (FIG. 6). Thus, so that it is possible to arbitrarily position the direction of the outer tube Wb2 within the range α when the first and second casing members 6, 7 are combined. That is, when trying to extend the operation wire Wa from the direction changing mechanism 5 to the transmission K toward a direction “a” (see FIG. 1), it is possible to direct the outer tube Wb2 toward the direction “a” by arbitrarily rotating the second casing member 7 relative to the first casing member 6 as shown in FIGS. 2 and 3. Similarly, when trying to extend the operation wire Wa from the direction changing mechanism 5 to the transmission K toward a direction “b” (see FIG. 7), it is possible to direct the outer tube Wb2 toward the direction “b” by arbitrarily rotating the second casing member 7 relative to the first casing member 6 as shown in FIGS. 4 and 5.

As described above, the direction changing mechanism 5 of the present embodiment can arbitrarily change the extending direction of the operation wire Wa by arbitrarily changing the extending direction of the operation wire Wa toward the securing portion 4. Thus, according to the present embodiment, the vehicle shift operation apparatus is provided with the direction changing mechanism 5. The direction changing mechanism 5 is arranged between the shift lever connecting portion 2a and the securing portion 4. The direction changing mechanism 5 can arbitrarily change the extending direction of the operation wire Wa. Thus, it is possible to efficiently convert the actuating force of the shift lever 2 to the operation of the operation wire Wa. This occurs by the utilization of parts other than a part secured to the securing portion 4. This enables use of the vehicle shaft operation apparatus even in car models with different relative positions between the vehicle shift operation apparatus and the transmission K.

In addition, the direction changing mechanism 5 of the present embodiment is disposed on the other side of the longitudinal axis L of the shift lever 2 with respect to the connecting portion 2a as shown in FIG. 1 (or FIG. 7). This makes it possible to reduce the size of the vehicle shift operation apparatus while reducing its dimensions in a fore and aft direction (the pivotal direction of the shift lever 2). Thus, according to the vehicle shift operation apparatus of the present embodiment, it can be applied to car models having different relative positions between the vehicle shift operation apparatus and the transmission K. The extending direction of the operation wire Wa may be changed by the direction changing mechanism 5. Thus, it is possible to set the position of the connecting portion 2a without being influenced by the extending direction of the operation wire Wa. Also, it is possible to set the position of the connecting portion 2a on the other side of the longitudinal axis L of the shift lever 2 with respect to the direction changing mechanism 5. Accordingly, the connecting portion 2a can be positioned behind the shift lever 2 on the opposite side to the portion that secures the securing portion 4. Thus, it is possible to reduce the fore and aft size of the vehicle shift operation apparatus.

In addition, the direction changing mechanism 5 of the present embodiment includes the pulley 8 supporting the operation wire Wa. The pulley 8 rotates, via the operation wire Wa, with the pivotal operation of the shift lever 2. Thus, it is possible to surely and smoothly transmit the motion of the operation wire Wa caused by the shift lever 2 to the transmission K. Furthermore, the direction changing mechanism 5 can arbitrarily change the extending direction of the operation wire Wa. This occurs by an arbitrary change of the extending direction of the operation wire Wa extending from the direction changing mechanism 5 to the securing portion 4. Thus, it is possible for the direction changing mechanism 5 to more easily and surely change the extending direction of the operation wire Wa.

Although the present disclosure has been described with reference to one preferable embodiment, modifications and alternations will occur to those of ordinary skill in the art upon reading and understanding the preceding detailed description. For example, the securing portion may be mounted on a position other than the bracket 3. Also, it is possible to arrange the direction changing mechanism 5 on the same side as the connecting portion 2a. In addition, the pulley 8, of the direction changing mechanism 5, can be replaced with any other part if it can be arranged between the shift lever connecting portion 2a and the securing portion 4 and change the extending direction of the operation wire Wa to any arbitrary direction.

The present disclosure can be applied to any type of vehicle shift operation apparatus with different external configurations or other additional functions if it can be arranged between the shaft level connecting portion and the securing portion and change the extending direction of the operation wire to any arbitrary direction.

The present disclosure has been described with reference to a preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A shift operation apparatus comprising:
a shift lever pivotally operated by a driver;
a bracket for pivotally mounting the shift lever;
an operation wire for connecting the shift lever and a vehicle transmission, the transmission being actuated through the operation wire by pivotally operating the shift lever;
outer tubes covering an external surface of the operation wire; and
a securing portion for securing one of the outer tubes to a predetermined position;
a direction changing mechanism disposed between a connecting portion of the operation wire with the shift lever and the securing portion of the outer tube, the direction changing mechanism arbitrarily changes the extending direction of the operation wire.

2. The vehicle shift operation apparatus of claim 1, wherein the direction changing mechanism is disposed on another side of a longitudinal axis of the shift lever with respect to the connecting portion.

3. The vehicle shift operation apparatus of claim 1, wherein the direction changing mechanism comprises a pulley supporting the operation wire, the pulley able to be rotated by the pivotal operation of the shift lever.

4. The vehicle shift operation apparatus of claim 1, wherein the direction changing mechanism can arbitrarily change the extending direction of the operation wire, by arbitrary change of the extending direction of the operation wire extending from the direction changing mechanism to the securing portion.
